(19) United States
(12) Patent Application Publication
(10) Pub. No.: US 2014/0358597 A1
(43) Pub. Date: Dec. 4, 2014

(54) SYSTEM AND METHOD FOR DYNAMIC PRICING OF RESERVATION INVENTORY

(71) Applicant: Versonix Corporation, San Jose, CA (US)

(72) Inventor: Leonid FEYDER, San Jose, CA (US)

(21) Appl. No.: 13/907,451

(22) Filed: May 31, 2013

(51) Int. Cl. G06Q 10/02; G06Q 30/02

(52) U.S. Cl. CPC G06Q 10/02; G06Q 30/0283
USPC 705/5

(57) ABSTRACT

A method and system for dynamic reservation pricing in a computer-based reservation system. A projected booking curve is defined for an event. Several time-dependent deviations may be defined to indicate a time shift relative to the projected booking curve. Price increases are associated with actual booking performance exceeding defined positive deviations, i.e., the time shift is ahead of the projected booking curve, and price decreases are associated with actual booking performance exceeding defined negative deviations, i.e., the time shift is behind the projected booking curve. When actual booking performance exceeds one of the defined deviations, the price is automatically increased or decreased in accord with the programmed settings for time shifts corresponding to the deviations.

### TECHNICAL FIELD

This disclosure relates generally to the field of computer-based reservation systems for travel and transportation, and more specifically, to a reservation system providing a method for dynamic pricing control.

### BACKGROUND

Computer-based reservation systems for travel and transportation are generally known, such as Seaware reservation software, sold by Versonix Corporation, of San Jose, Calif. Such systems provide automated solutions for management of reservation inventories for all modes of travel and transportation, such as cruise lines, ferries, resorts, cargo shipping, etc. For example, FIG. 1 shows a typical computer-based reservation system 10, wherein customer devices 11, 12 and/or 13 gain access via a network 20 to a reservation system 30, i.e., a software-based service hosted on a remote server.

The reservation system 30 may determine pricing for individual transactions using programmed criteria. However, such criteria generally provide static pricing levels. For example, pricing for consumer travel by ship or airplane may have programmed price increases on specific dates based on the number of days before departure. Many companies offer an “early booking discount” to encourage customers to book reservations early, subsequently raising rates as the departure date nears or if goals or thresholds for occupancy or revenue are reached. Different discount levels may be programmed based on the number of days before departure, as shown in Table I:

TABLE I

| # days before departure | discount |
|---|---|
| ≧100 | 45% |
| ≧60 | 35% |
| ≧30 | 25% |
| ≧10 | 15% |
| ≧5 | 5% |
| ≧2 | 0% |

Pricing may also be affected by reservation bookings running ahead or behind projected bookings. If actual booking performance does not match expectations, then pricing adjustments (up or down) can be made to reflect or influence demand. For example, if bookings are underperforming, then additional discounts could be offered; if bookings are over-performing, then current discounts could be reduced or ended. However, a system administrator typically makes such adjustments to pricing manually. Thus, it would be desirable if criteria could be set for making automated dynamic price adjustments without the need for administrative interaction.

### BRIEF DESCRIPTION OF THE DRAWINGS

FIG. 1 is a block diagram of a prior art computer-based reservation system.

FIG. 2A is a flowchart illustrating a process for dynamically adjusting reservation pricing.

FIG. 2B is a flowchart illustrating a more detailed process for the price determining step of FIG. 2A.

FIG. 3 is a graph illustrating an actual booking curve, i.e., the percentage of reservations actually booked versus the number of days until the event.

FIG. 4 is a graph illustrating a projected booking curve.

FIG. 5 is a graph illustrating a measure of days shifted for PLUS and MINUS adjustment regions relative to the projected booking curve of FIG. 4.

FIG. 6 is a graph illustrating the projected booking curve of FIG. 4 along with the adjusted booking curves of FIG. 5.

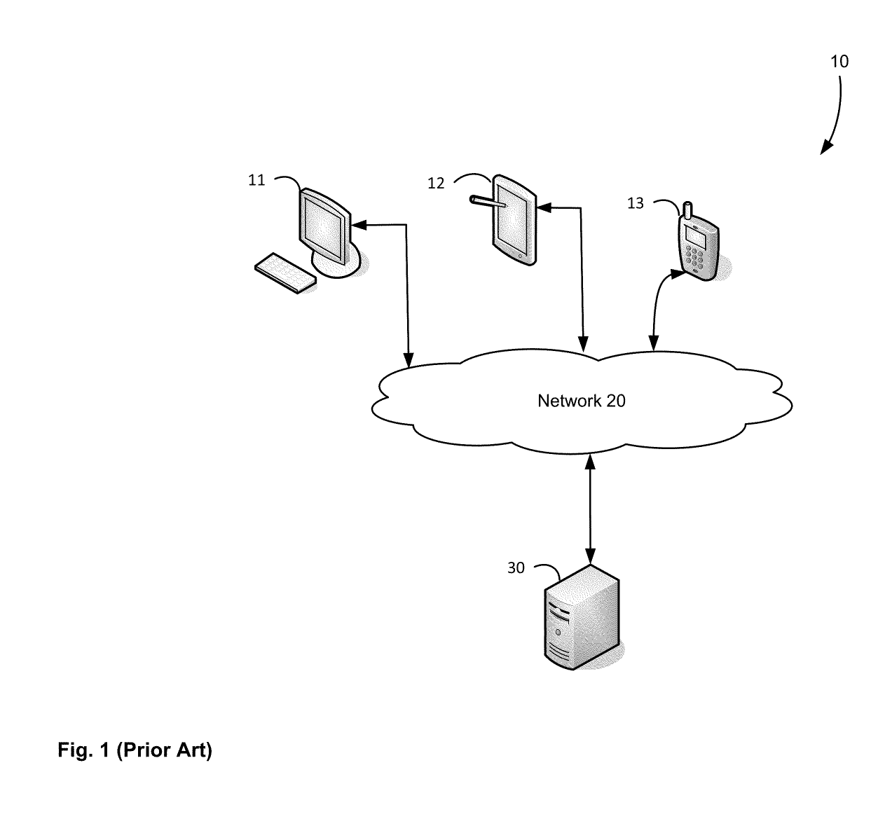

### DETAILED DESCRIPTION

A reservation system is described as having a process for automatically and dynamically adjusting the price of reservations. First, a projected booking curve is selected and associated with an event. Second, one or more deviations from the projected booking curve are defined to indicate a time shift away from the projected booking curve, the time shift indicating how many days actual bookings are ahead of or behind the projected booking curve. Third, the price of a reservation is automatically set and dynamically changed based on the time shift of actual booking performance relative to the projected booking curve.

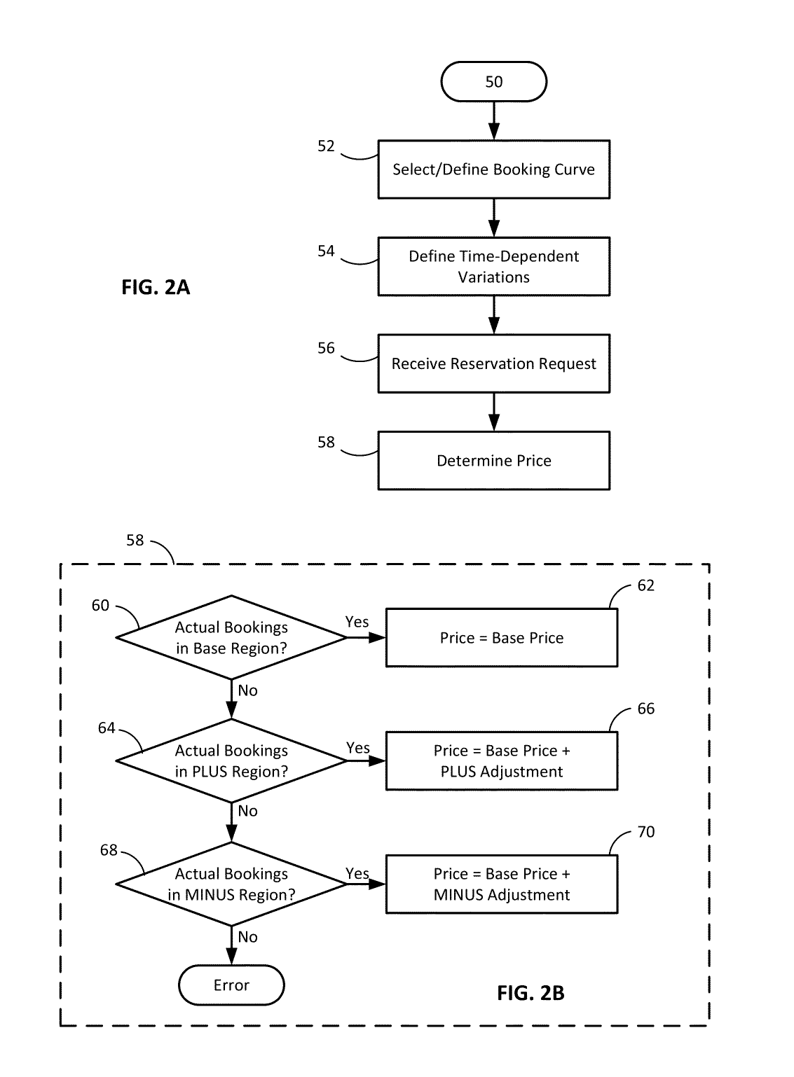

Referring now to FIG. 2A, a simple process 50 is illustrated for automated reservation pricing. In step 52, a projected booking curve is selected or defined. The projected booking curve illustrates expected demand for reservations by graphing the percentage of the reservation inventory actually booked versus the number of days before the event. In step 54, critical time-dependent deviations are defined to indicate time shifts relative to the projected booking curve. For example, a first “plus” adjustment region may be defined by deviations for actual booking performance that are 5 days ahead of the projected booking curve at the start of event sales and 2 days ahead of the projected booking curve at the end of event sales. Additional “plus” adjustment regions may be similarly defined by other deviation levels, and price increases may be associated with each of the plus adjustment regions. Likewise, a first “minus” adjustment region may be defined by deviations for actual booking performance that are 5 days behind the projected booking curve at the start of event sales and 2 days behind the projected booking curve at the end of event sales, as an example. Additional “minus” adjustment regions may be similarly defined by other deviation levels, and price decreases may be associated with each of the minus regions.

In step 56, a reservation request is received at the reservation system. In step 58, the price to assign to the reservation request is determined based on actual booking performance versus the booking curve.

The price determination step 58 is more fully detailed in FIG. 2B. In step 60, if actual booking performance is in the base region, i.e., it substantially tracks the projected booking curve, then price is set equal to a base price in step 62. The base price is typically set by an administrator based on an expected demand. If actual booking performance is time shifted into a plus region in step 64, then price is set equal to the base price plus a price increase as set for that plus region in step 66. If actual booking performance is time shifted into a minus region in step 68, then price is set equal to the base price plus a price decrease as set for that minus region in step 70.

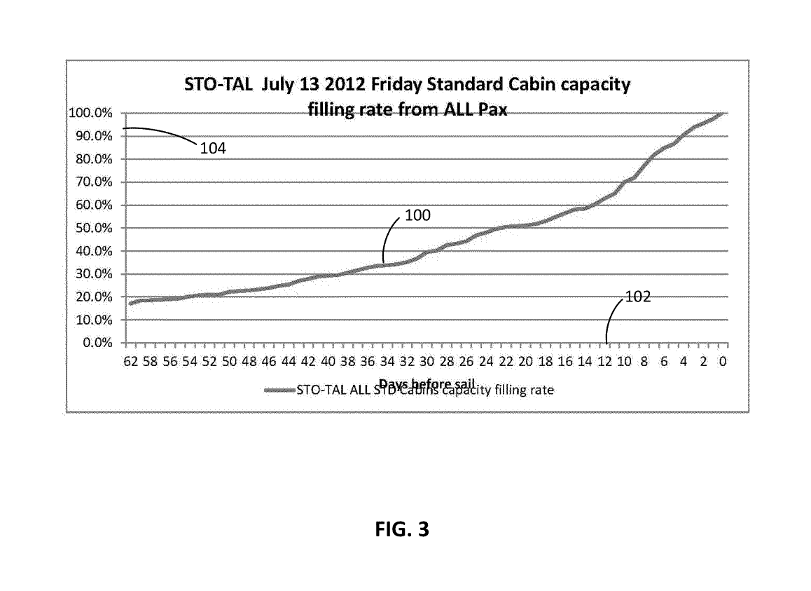

FIG. 3 illustrates an exemplary booking curve 100 for an event, such as a cruise ship voyage, where the x-axis 102 represents the number of days before the event, i.e., departure, and the y-axis 104 represents the percentage of the reservation inventory actually booked. Although no pricing or profitability information is reflected in the graph of FIG. 3, the booking curve 100 represents a reasonable standard for booking performance since the reservation inventory is 100% booked by the time the ship sails. Of course, many factors may influence demand for a particular event, and different booking curves may be defined or selected for different events.

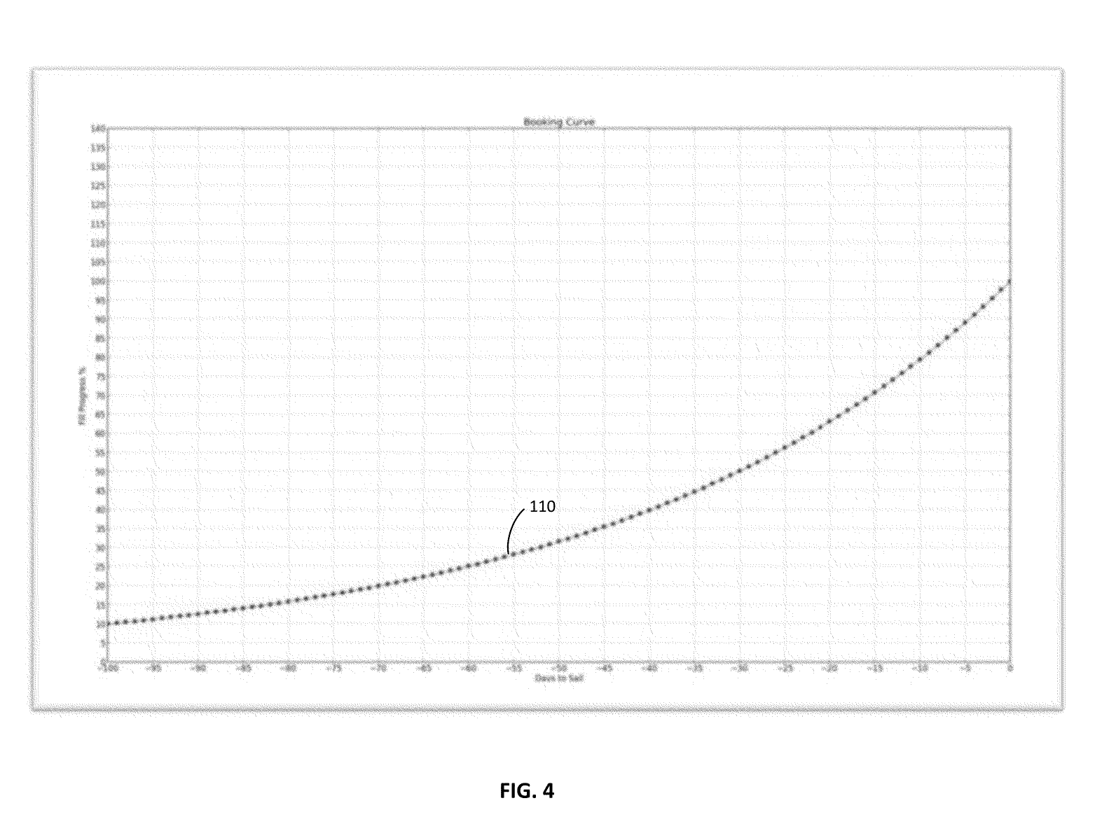

FIG. 4 illustrates a normalized or idealized version of the curve 100 shown in FIG. 3, and represents a booking curve no generated by program instructions executing on a computer as part of a computer-based reservation system. The booking curve 110 may be defined by having a user enter several points of the graph into a program module of the reservation system, with the program module then drawing the curve, or alternatively, by the program analyzing actual booking performance data for one or more similar events and then rendering an idealized curve.

For example, the administrator of the reservation system may choose a program option, perhaps presented in a programmed pop-up window, to select a projected booking curve from a list of predefined curves, or to define a projected booking curve by entering data in a field to define the curve.

Once a booking curve has been selected for a particular event, critical time-dependent deviations, i.e., time shifts from the projected booking curve are defined by the user. For example, a pop-up window may be configured which allows the user to enter values for the critical deviations. In one embodiment, a time-dependent deviation may be defined as a first fixed number of days ahead of or behind the projected booking curve at the start of the reservation sales and a second fixed number of days ahead of or behind the projected booking curve at the end of the reservation sales. Such deviations are called “days shift” or “time shift” herein. A positive days shift number indicates that reservation bookings are ahead of the projected booking curve by a positive number of days, whereas a negative days shift number indicates that reservation bookings are behind the projected booking curve by a negative number of days.

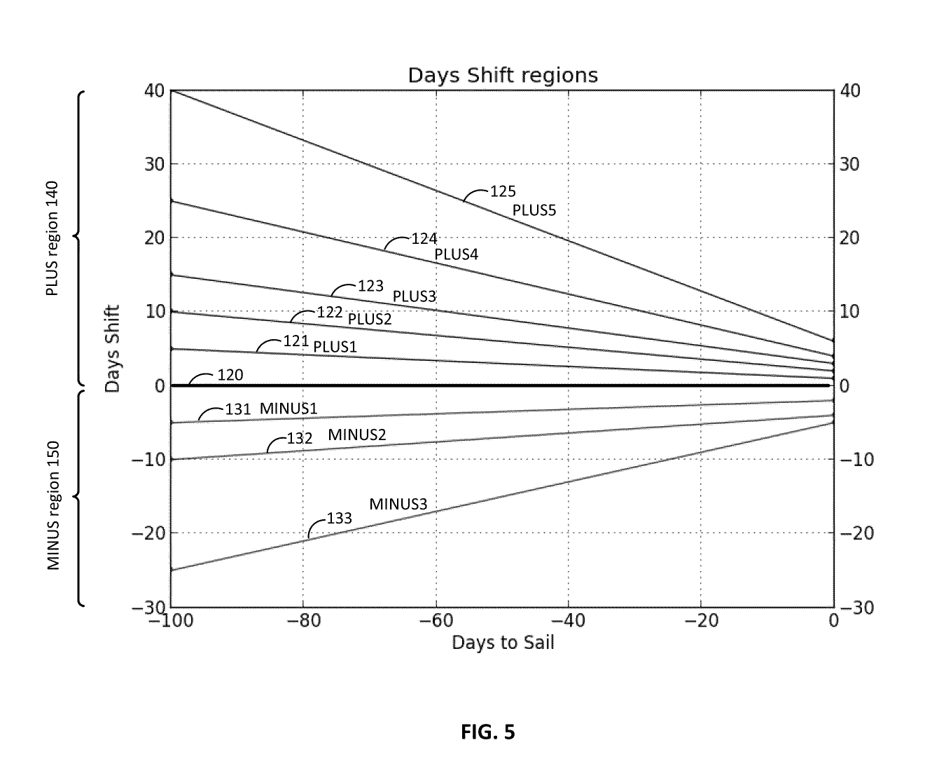

Referring now to FIG. 5, the programmed adjustments can be shown graphically on a plot graphing the days to the event or departure on the x-axis and the days shift on the y-axis. Curve 120 represents the same data as the projected booking curve 110 from FIG. 4, and is a straight line in this plot since there are no deviations or adjustments from the ideal performance represented by the projected booking curve 110.

The “plus” region 140 is the area above curve 120, i.e., ahead of the projected booking curve with a positive days shift, and a number of smaller adjustment regions can be defined in the plus region, such as line 121 entitled PLUS1, line 122 entitled PLUS2, line 123 entitled PLUS3, line 124 entitled PLUS4, and line 125 entitled PLUS5. Likewise, the “minus” region 150 is the area below curve 120, i.e., behind of the projected booking curve with a negative days shift, and a number of smaller adjustment regions can be defined in the minus region, such as line 131 entitled MINUS1, line 132 entitled MINUS2, and line 133 entitled MINUS3. For example, the value of each adjustment can be set as shown in Table II below, although other percentages or increments could be defined:

TABLE II

| adjustment region | price adjustment |
|---|---|
| PLUS5 | +35% |
| PLUS4 | +25% |
| PLUS3 | +15% |
| PLUS2 | +10% |
| PLUS₁ | +5% |
| MINUS₁ | −5% |
| MINUS₂ | −10% |
| MINUS₃ | −25% |

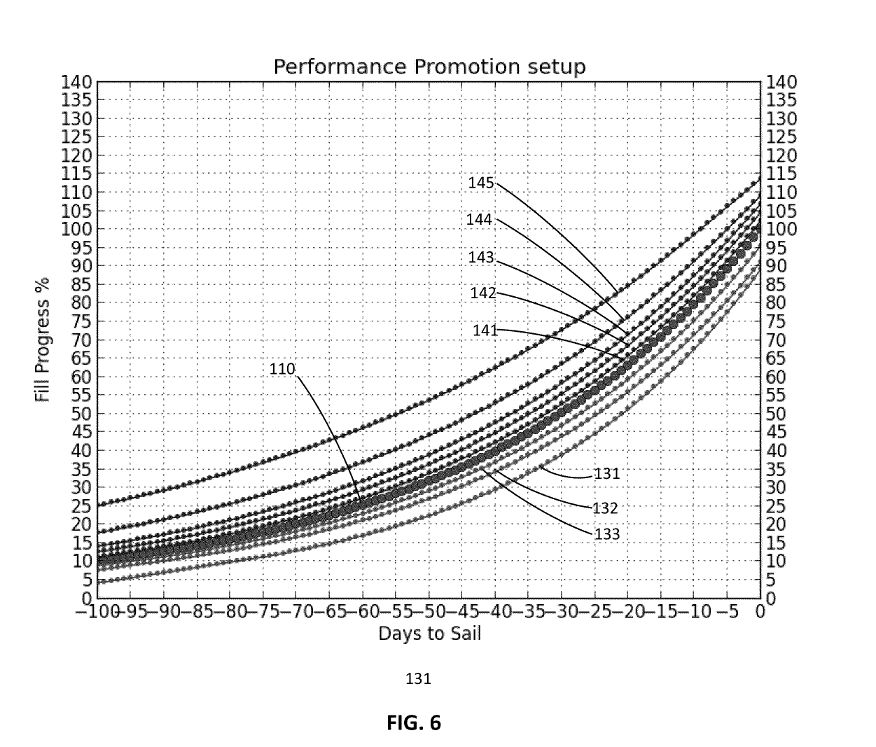

Referring now to FIG. 6, a plot 160 is shown of the projected booking curve 110 together with the plus adjustment curves 141-145 (corresponding to deviations PLUS1 through PLUS5) and the minus adjustment curves 131-133 (corresponding to deviations MINUS1 through MINUS3). The difference between the actual booking performance and the projected booking performance can be measured in number of days (including fractional results). Whenever the actual booking performance hits one of the PLUS lines, the price is automatically adjusted upward in accord with the programmed increase, for example, as set out in Table II. Whenever the actual booking performance hits one of the MINUS lines, the price is automatically adjusted downward in accord with the programmed decrease.

The base price would ordinarily be set when the event is first configured, but could be adjusted during the sale period as necessary without affecting the formulation for adjustments. Further, any number of adjustments or deviations to the price could be programmed, for example, to make increases or decreases more gradual or less gradual. Also, the amount or percentage of the adjustments can be modified as needed, but will affect the pricing if made during the sales period.

User devices 11, 12 and 13 may be any type of processor-based computing device, such as a desktop, laptop, tablet, smartphone, etc. Network 20 may be any type of processor-based computing network, such as the Internet, local area network, wide area network, etc. Reservation system 30 may be a standard processor-based server configured with an operating system and suitable instructions to execute programmed routines.

In one embodiment, a computer program product has instructions encoded on a machine-readable storage medium, which can be used to program a computer to perform any of the processes of the embodiments described herein. Computer code for operating and configuring the system to intercommunicate and to process data as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for pricing reservations for an event in a computer-based reservation system, comprising:
selecting a projected booking curve for an event, the projected booking curve illustrating a percentage of the total inventory of reservations for the event that are booked versus a number of days until the event;
defining a plurality of deviations relative to the projected booking curve, including at least one plus deviation and at least one minus _deviation, the plus deviation representing booking performance ahead of the projected booking curve, the minus deviation representing booking performance behind the projected booking curve;
receiving a reservation request for the event;
assigning a price to the reservation request, the price being equal to a base price if actual booking performance does not exceed any of the deviations, the price being equal to the base price increased by a plus adjustment if actual booking performance exceeds the plus deviation, and the price being equal to the base price decreased by a minus adjustment if actual booking performance exceeds the minus deviation.

2. The method of claim 1, further comprising:
defining a plurality of plus deviations and a plurality of minus deviations relative to the projected booking curve, the plus deviations defining a plurality of adjustment regions in the plus region and a plurality of adjustment regions in the minus region, wherein each adjustment region in the plus region defines a different increase amount to the plus adjustment and each adjustment region in the minus region defines a different decrease amount for the minus adjustment.

3. The method of claim 2, further comprising:
assigning an incremental increase or decrease amount to each of the plurality of adjustment regions.

4. The method of claim 2, further comprising:
assigning a specific percentage of the base price as the increase or decrease amount to each of the plurality of adjustment regions.

5. The method of claim 1, further comprising:
modifying the base price.

6. The method of claim 1, further comprising:
defining a plurality of projected booking curves for the event.

7. The method of claim 1, further comprising:
modifying the projected booking curve.

8. A non-transitory computer-readable storage medium encoded with executable instructions for pricing reservations for an event in a computer-based reservation system, the instructions comprising:
selecting a projected booking curve for an event, the projected booking curve illustrating a percentage of the total inventory of reservations for the event that are booked versus a number of days until the event;
defining a plurality of deviations relative to the projected booking curve, including at least one plus deviation and at least one minus deviation, the plus deviation representing booking performance ahead of the projected booking curve, the minus deviation representing booking performance behind the projected booking curve;
receiving a reservation request for the event;
assigning a price to the reservation request, the price being equal to a base price if actual booking performance does not exceed any of the deviations, the price being equal to the base price increased by a plus adjustment if actual booking performance exceeds the plus deviation , and the price being equal to the base price decreased by a minus adjustment if actual booking performance exceeds the minus deviation.

9. The computer-readable storage medium of claim 8, the instructions further comprising:
defining a plurality of plus deviations and a plurality of minus deviations relative to the projected booking curve, the plus deviations defining a plurality of adjustment regions in the plus region and a plurality of adjustment regions in the minus region, wherein each adjustment region in the plus region defines a different increase amount to the plus adjustment and each adjustment region in the minus region defines a different decrease amount for the minus adjustment.

10. The computer-readable storage medium of claim 9, the instructions further comprising:
assigning an incremental increase or decrease amount to each of the plurality of adjustment regions.

11. The computer-readable storage medium of claim 9, the instructions further comprising:
assigning a specific percentage of the base price as the increase or decrease amount to each of the plurality of adjustment regions.

12. The computer-readable storage medium of claim 8, the instructions further comprising:
modifying the base price.

13. The computer-readable storage medium of claim 8, the instructions further comprising:
defining a plurality of projected booking curves for the event.

14. The computer-readable storage medium of claim 8, the instructions further comprising:
modifying the projected booking curve.

15. A computer-based reservation system with dynamic pricing of reservations, comprising:
a processor-based server; and
one or more stored sequences of instructions which, when executed by the processor-based server, cause the processor-based server to carry out the steps of:
selecting a projected booking curve for an event, the projected booking curve illustrating a percentage of the total inventory of reservations for the event that are booked versus a number of days until the event;
defining a plurality of deviations relative to the projected booking curve, including at least one plus deviation and at least one minus deviation, the plus deviation representing booking performance ahead of the projected booking curve, the minus deviation representing booking performance behind the projected booking curve;
receiving a reservation request for the event;
assigning a price to the reservation request, the price being equal to a base price if actual booking performance does not exceed any of the deviations, the price being equal to the base price increased by a plus adjustment if actual booking performance exceeds the plus deviation, and the price being equal to the base price decreased by a minus adjustment if actual booking performance exceeds the minus deviation.
